(19) United States
(12) Patent Application Publication
(10) Pub. No.: US 2007/0170258 A1
(43) Pub. Date: Jul. 26, 2007

(54) Document reading device and document reading method

(76) Inventor: Yoshinobu Kagami, Kanagawa (JP)

Correspondence Address: HARNESS, DICKEY & PIERCE, P.L.C., P.O. BOX 8910, RESTON, VA, 20195, US

(21) Appl. No.: 11/655,974

(22) Filed: Jan. 22, 2007

(30) Foreign Application Priority Data
Jan. 26, 2006 (JP) 2006-017679

(51) Int. Cl. G06K 7/10

(52) U.S. Cl. 235/454

(57) ABSTRACT

A frequency of an original clock signal is spread based on a spread spectrum width thereby generating a real clock signal, and a timing signal is generated based on the real clock signal. Noise in the timing signal is reduced in a plurality of harmonic noise reduction stages to thereby obtain a noise-reduced timing signal. An optical image obtained by scanning a document is converted into an electric signal based on the noise-reduced timing signal. The spread spectrum width to be used when spreading frequency of an original clock signal, and number of the harmonic noise reduction stages to be used when reducing noise in the timing signal are changed depending on an operation mode.

### CROSS-REFERENCE TO RELATED APPLICATIONS

The present document incorporates by reference the entire contents of Japanese priority document, 2006-017679 filed in Japan on Jan. 26, 2006.

### BACKGROUND OF THE INVENTION

1. Field of the Invention

The present invention generally relates to a document reading device, and specifically relates to suppressing radiation noise in a document reading device.

2. Description of the Related Art

A document reading device is used as an image reading device, i.e., a scanner, in image forming apparatuses such as a copying machine. FIG. 6 is a schematic of a conventional document reading device. The conventional document reading device includes a light source lamp, a first carriage, a second carriage, a lens optical system, and a charge-coupled device (CCD). The CCD is used to convert a light signal into electric signal. The document reading device reads a document placed on a contact glass. The first carriage and the second carriage scan a surface of a document by moving in the right-hand direction of the diagram. A motor (not shown) moves the first carriage and the second carriage.

Resolution and speed of image forming apparatuses are being increased day by day. To realize high-resolution and high-speed, a clock and timing pulses at higher speed must be supplied to an image processing circuit. However, radiation noise level rises with an increase in the speed of the clock and the timing pulses.

One approach to suppress the radiation noise is to spread the frequencies of the clock and the timing pulses. FIG. 7 is a block diagram of a CCD driving circuit in the conventional document reading device that uses the technique of spreading the frequencies of the clock and the timing pulses. Operations performed in the CCD driving circuit of the document reading device will be explained with reference to FIG. 7. The CCD driving circuit includes an oscillator (OSC), an SSCG, a timing generator, a driver integrated chip (IC), a CCD, and three analog front-ends (AFE). The OSC is a crystal oscillator or the like that generates a reference clock. The SSCG spreads a frequency. The timing generator generates each timing signal based on the clock. The driver IC drives timing signals to the CCD, IC, and the like. The CCD is used to photoelectrically convert an image picked up using optical imaging. Each of the three AFEs amplifies or sample-holds an analog image signal from the CCD and performs an analog-to-digital (A/D) conversion to convert the analog image signal to a digital image signal. A resistor R arranged between the driver IC and the CCD is a damping resistor that damps the timing signals. A resistor-capacitor (RC) integration circuit is formed by the resistor R and a capacitive load of the CCD, other IC, and the like. In the circuit shown in FIG. 7, only CCD driving signals φ1 and φ2 are shown as outputs from the driver IC. In actuality, more timing signals are output from the driver IC. The function of the resistor R is to reduce high-frequency noise caused by undershoot or overshoot of the timing signal, thereby securing a normal output voltage and reducing electromagnetic interference (EMI). A color document reading device that uses a color CCD is shown herein. However, the same applies to monochrome document reading devices, as well.

FIG. 8A to FIG. 8F are diagrams for explaining the timing signal. FIG. 8A to FIG. 8C show a CCD driving signal φ1 having lower frequency. FIG. 8A shows an output from the driver IC. FIG. 8B shows a CCD terminal input when the damping resistance is small. FIG. 8C shows the CCD terminal input when the damping resistance is large.

FIG. 8D to FIG. 8F show the CCD driving signal φ1 having higher frequency. FIG. 8D shows an output from the driver IC. FIG. 8E shows a CCD terminal input when the damping resistance is small. FIG. 8F shows the CCD terminal input when the damping resistance is large. In FIG. 8B and FIG. 8E, a time constant of the RC-integration circuit is small so that these waveforms depart more from a circle. In FIG. 8C and FIG. 8F, the time constant of the RC-integration circuit is large so that these waveforms depart less from a circle.

The timing signals of the CCD are regulated for each CCD. For example, a lower limit of an H-width (period during which voltage is 4.5 volts or more) of the φ1 is 10 nanoseconds. In other words, if the damping resistance (namely, the time constant) is made too large merely to reduce the EMI, the required H-width cannot be obtained. FIG. 8F shows a state in which the regulation cannot be met, when the frequency is high and the damping resistance is large.

When the clock frequencies spread, timings shift when an electrical charge of each pixel from the CCD is transferred and detected. Therefore, the level of the electrical charge cannot be correctly detected. Intensity level of each read pixel is disrupted, and the image quality degrades. Japanese Patent Application Laid-open No. 2005-151296 describes a mechanism by which stripe-shaped patches are formed in an image when the frequency is spread. The document reading device cannot be properly operated when the waveform is significantly rounded. Thus, there are limits to a size of the time constant. In this way, the SSCG is used, or the time constant of the timing signal is increased and the waveform is rounded, to suppress the EMI. Hereafter, some examples of conventional technology related to the above-mentioned methods of suppressing EMI will be explained.

An image forming apparatus disclosed in Japanese Patent Application Laid-open No. 2004-260541 is configured to suppress generation of radiation noise, while suppressing an effect of image noise to an output image, by adjusting a spread spectrum width of the timing pulses according to image mode. The timing pulses drive an image reading unit. The image reading unit reads an image, performs predetermined conversions, and outputs the image as image signals. The same timing pulses drive an image processing unit. The image processing unit processes images to output the image according to predetermined image processing and image quality modes, based on the image signals. The frequency of the timing pulses is spread so that a reference frequency is continuously modulated at a predetermined cycle. The spread-spectrum width changes depending on the image quality mode.

An image reading apparatus disclosed in Japanese Patent Application Laid-open No. 2005-151296 reduces stripes that are formed in a read image by not changing a shape of a CCD output waveform, even when a spread-spectrum clock is used as a CCD driving clock. A spread-spectrum clock generating unit internally converts a reference clock from an oscillator to the spread-spectrum clock and generates various timing signals for driving a CCD, an AFE, and an A/D converter from the spread-spectrum clock. A CCD driving clock selecting unit selects a clock, among a plurality of CCD driving clocks, to become a clock of which an H-period or an L-period, during which the frequency is not spread, becomes a fixed width. The spread-spectrum clock generating unit can generate the CCD driving clock of which the H-period or the L-period becomes a fixed width by, for example, taking an AND of a divided clock and a negative logic of a delay clock. The divided clock is a divided spread-spectrum clock. The delay clock is a delayed divided clock.

However, conventionally, radiation noise (EMI) cannot be suppressed when the spread-spectrum width is decreased in high-quality mode, such as in photograph mode.

### SUMMARY OF THE INVENTION

It is an object of the present invention to at least partially solve the problems in the conventional technology.

According to an aspect of the present invention, a document reading device includes a light source that irradiates a document; an optical system that receives light reflected from the document and creates an optical image of the document from received light; a photoelectric converting unit that converts the optical image into an electric signal based on a noise-reduced timing signal; a clock generating unit that generates an original clock signal; a spread spectrum unit that spreads the frequency of the original clock signal based on a spread spectrum width thereby generating a real clock signal; a timing-signal generating unit that generates a timing signal based on the real clock signal; a driving unit that supplies the timing signal to the photoelectric converting unit; a harmonic-noise reducing unit that reduces harmonic noise of the timing signal in a plurality of harmonic noise reduction stages and supplies noise-reduced timing signal to the photoelectric converting unit; a spread-spectrum control unit that sets the spread spectrum width in the spread spectrum unit; and a noise-reduction setting control unit that determines a combination of the spread spectrum width to be set by the spread-spectrum control unit and number of the harmonic noise reduction stages to be used by the harmonic-noise reducing unit depending on an operation mode.

According to another aspect of the present invention, a document reading method includes spreading a frequency of an original clock signal based on a spread spectrum width thereby generating a real clock signal; generating a timing signal based on the real clock signal; reducing noise in the timing signal in a plurality of harmonic noise reduction stages to thereby obtain a noise-reduced timing signal; converting an optical image obtained by scanning a document into an electric signal based on the noise-reduced timing signal; and setting the spread spectrum width at the spreading and number of the harmonic noise reduction stages at the reducing depending on an operation mode.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a circuit block diagram of a document reading device according to a first embodiment of the present invention;

FIG. 1B is a table for explaining ON/OFF combinations of MOSFET and SSCG;

FIG. 2 is a flowchart of a control procedure performed by the document reading device shown in FIG. 1A;

FIG. 3A is circuit block diagram of a document reading device according to a second embodiment of the present invention;

FIG. 3B is a flowchart of a control procedure performed by the document reading device shown in FIG. 3A;

FIG. 4A is circuit block diagram of a document reading device according to a third embodiment of the present invention;

FIG. 4B is a flowchart of a control procedure performed by the document reading device shown in FIG. 4A;

FIG. 5 is a circuit block diagram of a document reading device according to a fourth embodiment of the present invention;

FIG. 6 is a schematic of a conventional document reading device;

FIG. 7 is a block diagram of a control circuit of the conventional document reading device; and

FIGS. 8A to 8F are waveforms of timing signals in the conventional control circuit.

### DETAILED DESCRIPTION OF THE PREFERRED EMBODIMENTS

Exemplary embodiments of a document reading device according to the present invention are explained below with reference to accompanying drawings.

A document reading device according to a first embodiment of the present invention changes ON/OFF of spread spectrum and a size of a time constant of a timing signal depending on operation mode. The operation mode is, for example, high-speed medium-image-quality mode or medium-speed high-image-quality mode.

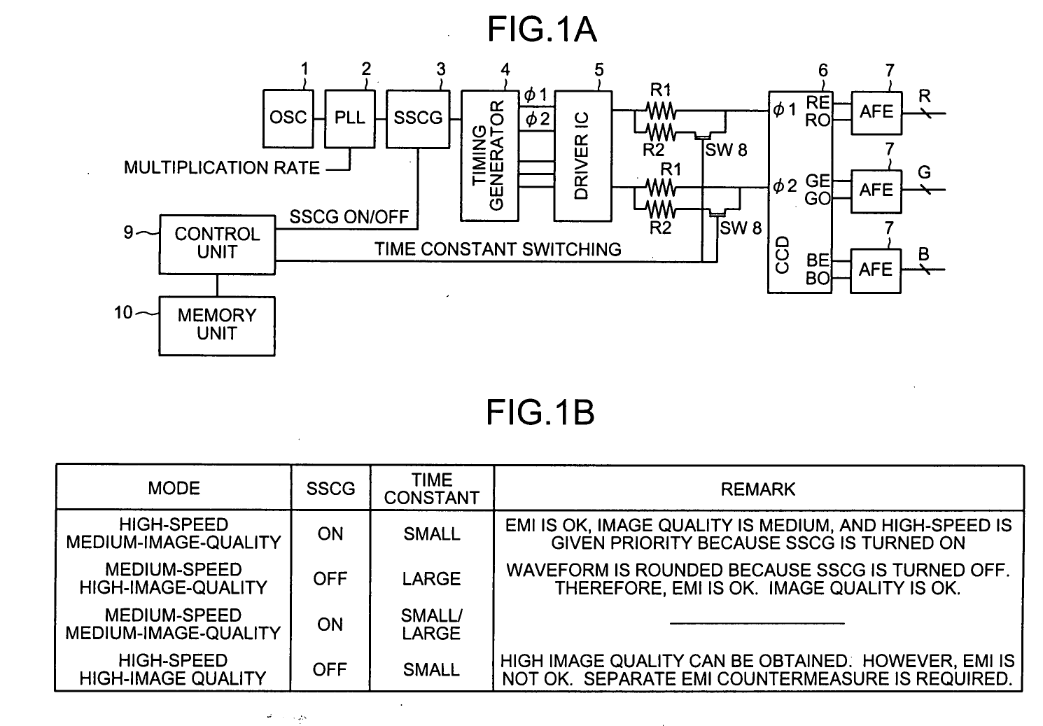

FIG. 1A is a functional block diagram of a CCD driving circuit in the document reading device according to the first embodiment. An OSC 1 is a crystal oscillator (clock generating unit) that generates a reference clock. A PLL 2 is a phase-locked loop circuit that multiplies the reference clock and generates an original clock. An SSCG 3 is a spread spectrum unit that selects whether to spread the frequency of the original clock and generates a real clock. The spread spectrum can be that in which the frequencies are regularly changed or randomly changed. A timing generator 4 is a timing-signal generating unit that generates various timing signals from the clock outputted from the SSCG 3. A driver IC 5 is a driver unit that generates a driving signal from a timing signal and provides the driving signal to a CCD 6. The CCD 6 is a photoelectric converting unit) that photoelectrically converts an image picked up using optical imaging. Each of a plurality of AFEs 7 amplifies an analog image signal from the CCD, sample and holds the amplified signal, and performs an A/D conversion to convert the signal to a digital image signal. Damping resistors R1 and R2 determine a time constant of the driving signal. The damping resistors R1 and R2 are combined with stray capacitance, forming a RC-integration circuit. The RC-integration circuit is a low-pass filter that has characteristics that depend on the time constant. A switch (SW) 8 is a metal-oxide semiconductor field-effect transmitter (MOSFET) that switches the damping resistors.

The PLL 2 is arranged between the OSC 1 and the SSCG 3. The damping resistors R1 and R2 are connected in parallel. The switch 8, which is the MOSFET, is serially connected to the damping resistor R2. The PLL 2 multiplies the frequency of the reference clock from the OSC 1 (by 0.5, by 0.75, by 1, by 1.5, by 2, etc.). The multiplication factor can be set depending on whether an output terminal is at logical high or low.

The time constant becomes large when the switch 8 is OFF, and becomes small when the switch 8 is ON. The SSCG 3 also performs a function of turning ON/OFF of the spectrum spread. By changing the logical level of the terminal, it is possible to select a clock of which the frequency is spread or a clock of which the frequency is not spread. The combinations of the switch 8 being turned ON/OFF and the SSCG 3 being turned ON/OFF are set as shown in the table in FIG. 1B. A control unit 9 (spread-spectrum control unit and noise-reduction setting control unit) provided in the document reading device sets the combination. The control unit 9 can be a central processing unit (CPU). The table in FIG. 1B is stored in advance in a memory unit 10, such as a read-only memory, that can be read by the control unit.

As shown in FIG. 1B, in high-speed medium-image-quality mode, the SSCG 3 is ON, the time constant is small, and the frequency is spread. High-speed medium-image-quality mode is, for example, monochrome mode, and gives priority to high-speed over image quality. Therefore, in high-speed medium-image-quality mode, there is little radiation noise, and EMI regulation is met.

In medium-speed high-image-quality mode, the SSCG 3 is OFF, the time constant is large, and the frequency is not spread. Medium-speed high-image-quality mode is, for example, color mode, and gives priority to image quality over speed. However, in medium-speed high-image-quality mode, the time constant can be set to large so that there is little harmonic radiation noise and the EMI regulation is met.

In medium-speed medium-image-quality mode, the SSCG 3 is ON, the time constant can be set to large or small, and the frequency is spread. Medium-speed medium-image-quality mode does not require speed or image quality, but can be selected when silence or energy conservation is required. Therefore, in medium-speed medium-image-quality mode, there is little radiation noise, and the EMI regulation is met.

Finally, in high-speed high-image-quality mode, the SSCG 3 is OFF, and the time constant is set to small. In high-speed high-image-quality mode, a high image quality can be obtained at a high speed; however, there is significant radiation noise, and the EMI regulation is not met. As a result, high-speed high-image-quality mode cannot be used without implementing a separate countermeasure.

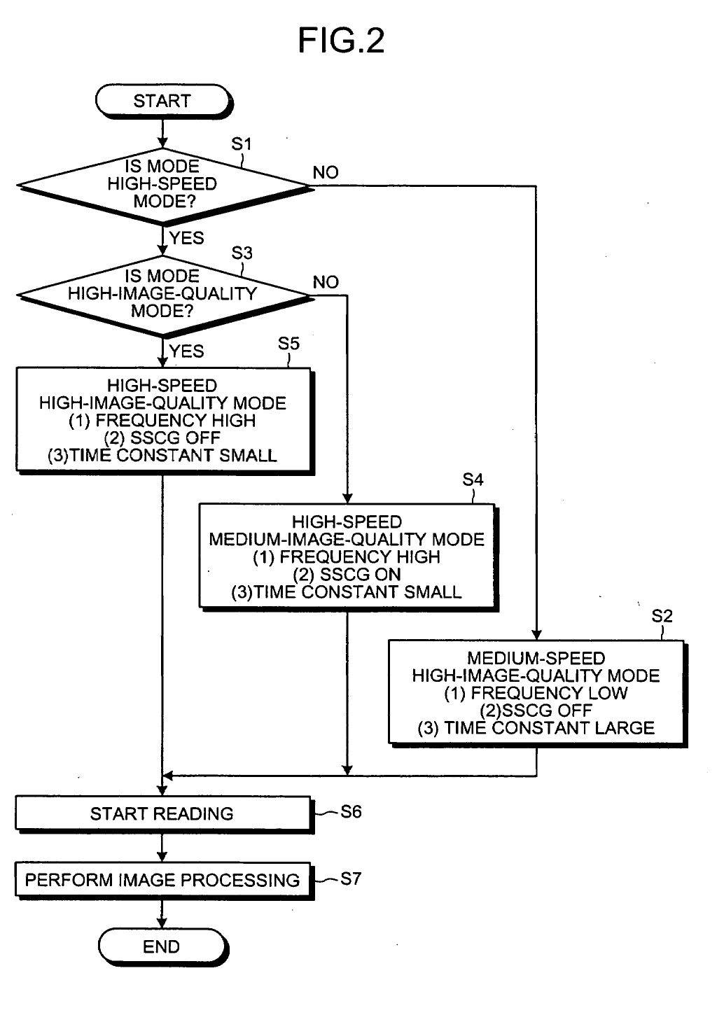

FIG. 2 is a flowchart of operations performed by the document reading device according to the first embodiment. Each process included in the flowchart is performed under the control of the control unit 9. The document reading device can be set to high-speed medium-image-quality mode or medium-speed high-image-quality mode. A user selects the mode using a touch-key (not shown) or the like. First, at Step S1, the control unit judges whether the document reading device is in high-speed mode. If the document reading device is not in high-speed mode (NO at step S1), the control unit sets the document reading device to medium-speed high-image-quality mode (Step S2). If the document reading device is in high-speed mode (YES at step S1), the control unit judges whether the document reading device is in high-image-quality mode (Step S3). If the document reading device is not in high-image-quality mode (NO at step S3), the control unit sets the document reading device to high-speed medium-image-quality mode (Step S4). If the document reading device is in high-image-quality mode (YES at step S3), the control unit sets the document reading device to high-speed-high-image-quality mode (Step S5). When a mode is set in this manner, the control unit 9 starts reading at Step S6. When the reading is completed, the control unit 9 performs image processing at Step S7.

In this way, when any one of high-speed medium-image-quality mode, medium-speed high-image-quality mode, and high-speed high-image-quality mode is selected, the control unit 9 sets the frequency of the mode, ON/OFF of the SSCG 3, and the time constant. Then, the control unit 9 starts reading a document. The frequency is set by a multiplication factor setting terminal of the PLL 2. The ON/OFF of the SSCG 3 is set by the terminal of the SSCG 3. The time constant is set by a switch terminal. A spread width can be changed instead of turning ON/OFF of the spread spectrum. Alternatively, a gate voltage of the switch 8 can be set.

As example in which the spread spectrum and the time constant are selected depending on the operation mode is explained. However, the spread spectrum width and the time constant can simply be selected depending on operation frequency. An example of the RC-integration circuit is explained as a harmonic-noise reducing unit that reduces harmonic noise. However, the same results can be obtained by the use of other low-pass filters. High-speed high-image-quality mode is a high-image-quality monochrome mode, a high-speed color mode, and the like. The frequency is not spread or the spread width is small, and the time constant is small. Therefore, the EMI is not reduced. In this case, implementation of other radiation noise countermeasures is required, such as use in a shield room.

As described above, the document reading device according to the first embodiment selects ON/OFF of the spread spectrum and the size of the time constant of the timing signal depending on the operation mode. Therefore, it is possible to suppress occurrence of radiation noise and maintain the image quality in even in high-image-quality mode or high-speed mode.

A document reading device according to a second embodiment of the present invention selects ON/OFF of the spread spectrum, the spread spectrum width, and size of the time constant of the timing signal depending on the operation mode. The operation mode is, for example, high-speed medium-image-quality mode or medium-speed high-image-quality mode.

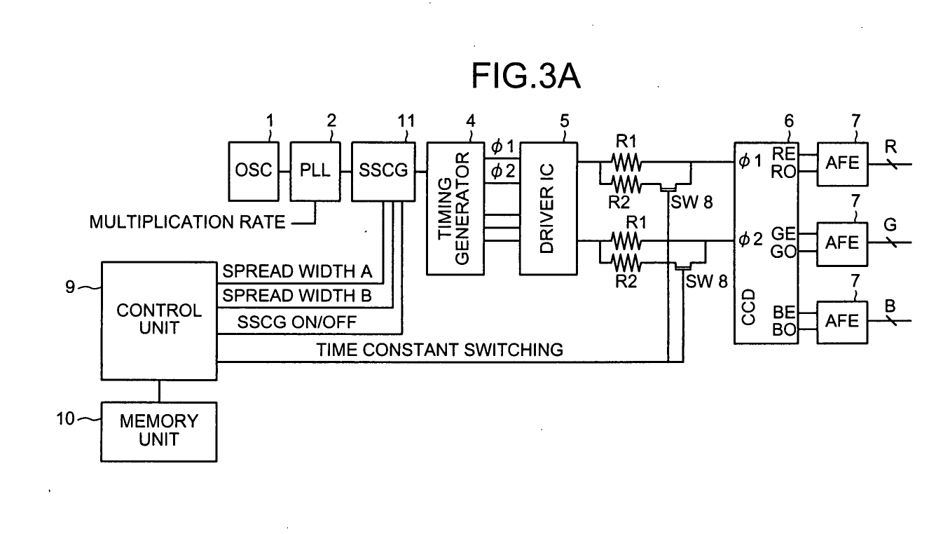

FIG. 3A is a functional block diagram of a CCD driving circuit of the document reading device according to the second embodiment. FIG. 3B is a flowchart of a control procedure performed by the document reading device according to the second embodiment. The configuration of the document reading device is almost the same as that according to the first embodiment except that an SSCG 11 is used instead of the SSCG 3. The SSCG 11 is a spread spectrum unit that can select the spread spectrum width and the ON/OFF of the spread spectrum.

The SSCG 11 has a terminal that selects the spread width of the frequencies in addition to a control terminal for turning ON/OFF the spread spectrum. The terminal is the same as that shown in FIG. 2 of Japanese Patent Application Laid-open No. 2004-260541. Ideally, the EMI regulation is met without the frequency being spread. However, when the frequency is required to be spread, a minimum spread width is preferable to reduce stripes that become noise in the image. Therefore, if the EMI regulation is met even when the spread width is small, the spread width is set to small (select spread width A) when the SSCG 11 is turned ON in FIG. 3A. When the spread width can be selected in this way, a required spread width can be selected in each mode. The SSCG 11 being turned ON and the spread width B being set corresponds to a state in which the SSCG 3 according to the first embodiment is turned ON. Processes are basically the same as those according to the first embodiment, as shown in FIG. 3B. However, a small spread width (spread width A) is selected when the document reading device is in high-speed medium-image-quality mode (Step S8). If a spread spectrum width when the spread spectrum is turned OFF is considered to be zero, the spread spectrum being turned OFF can be included in the selection of the spread spectrum width. Therefore, the spread spectrum being OFF may be expressed by the spread width being zero.

As described above, the document reading device according to the second embodiment selects ON/OFF of the spread spectrum, the spread spectrum width, and the size of the time constant of the timing signal depending on the operation mode. Therefore, it is possible to suppress occurrence of radiation noise and maintain image quality even in high-image-quality mode or high-speed mode.

A document reading device according to a third embodiment of the present invention selects ON/OFF of the spread spectrum and values of consecutive time constants of the timing signal depending on the operation mode. The operation mode is, for example, high-speed medium-image-quality mode or the medium-speed high-image-quality mode.

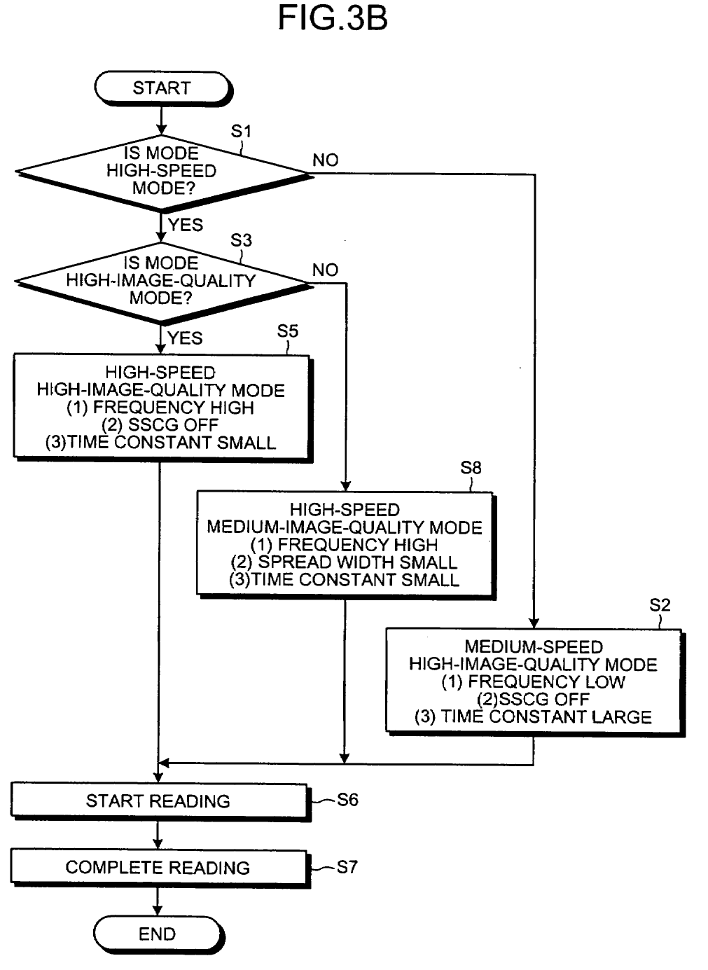

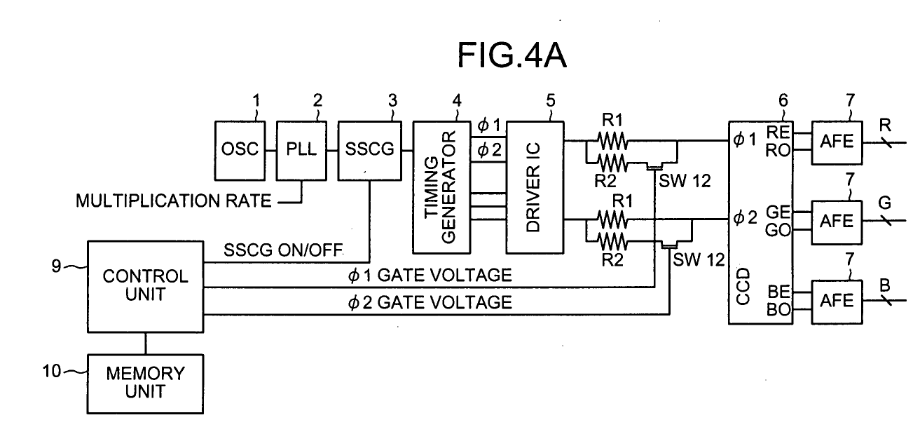

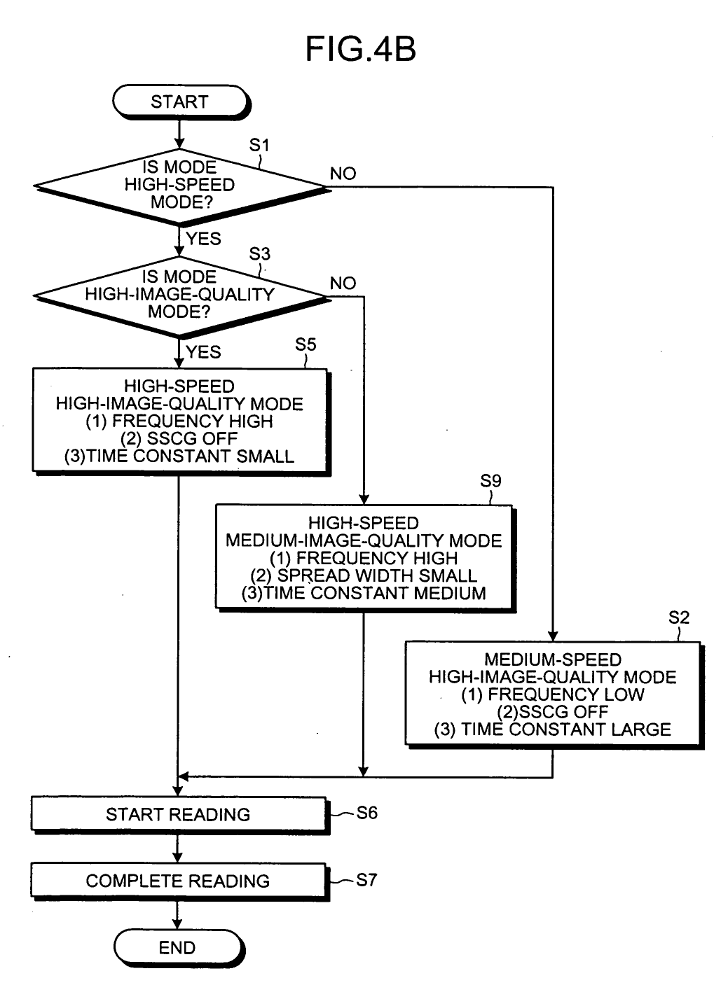

FIG. 4A is a functional block diagram of a CCD driving circuit in the document reading device according to the third embodiment. FIG. 4B is a flowchart of a control procedure performed by the document reading device according to the third embodiment. The configuration of the document reading device is almost the same as that according to the first embodiment except that a switch 12 is used instead of the switch 8. The switch 12 is a MOSFET that continuously switches the damping resistors and it functions as a time constant setting unit.

The switch 12 is not used as a simple switch; however, it is used as a time constant setting unit that sets an ON resistance value under control of the gate voltage. As a result, an allowable threshold time constant of the timing signal is selected for each frequency. In other words, the waveform can be rounded to a maximum limit possible at a certain frequency. As a result, the harmonic noise can be minimized. At the same time, the EMI regulation can be met even when the spread spectrum width is small. Therefore, the stripes in the image caused by the spread spectrum are few. The processes are basically the same as those according to the first embodiment, as shown in FIG. 4B. However, the time constant is set to about medium when the document reading device is in high-speed medium-image-quality mode (Step S9).

As described above, the document reading device according to the third embodiment selects ON/OFF of the spread spectrum and the values of the consecutive time constants of the timing signal, depending on the operation mode. Therefore, it is possible to suppress occurrence of radiation noise and maintain image quality even in high-image-quality mode or high-speed mode.

A document reading device according to a fourth embodiment of the present invention selects ON/OFF of the spread spectrum and size of the time constant of the timing signal depending on the operation mode. The operation mode is, for example, high-speed medium-image-quality mode or medium-speed high-image-quality mode. The document reading device selects the size of the time constant using an output terminal of a driver IC.

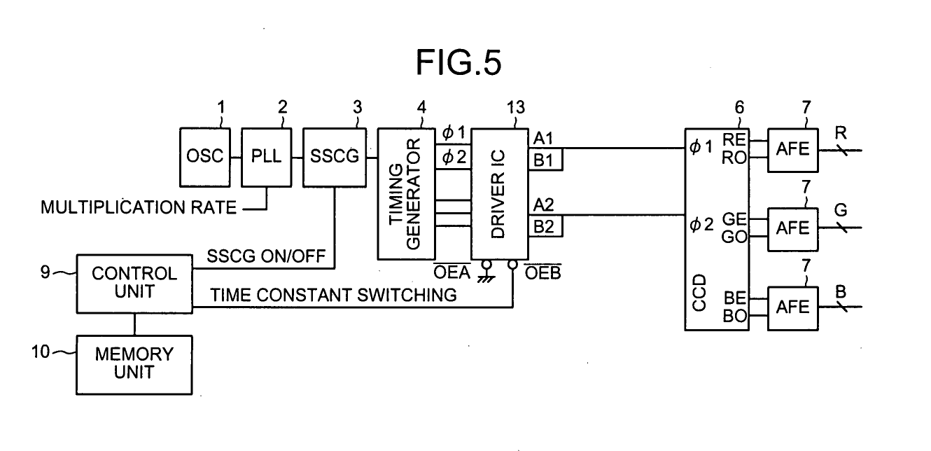

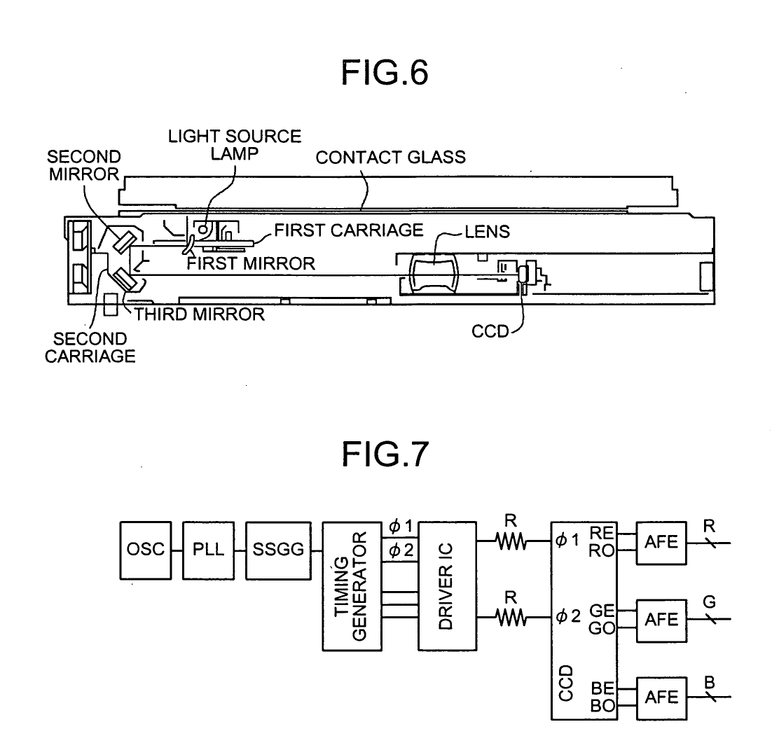

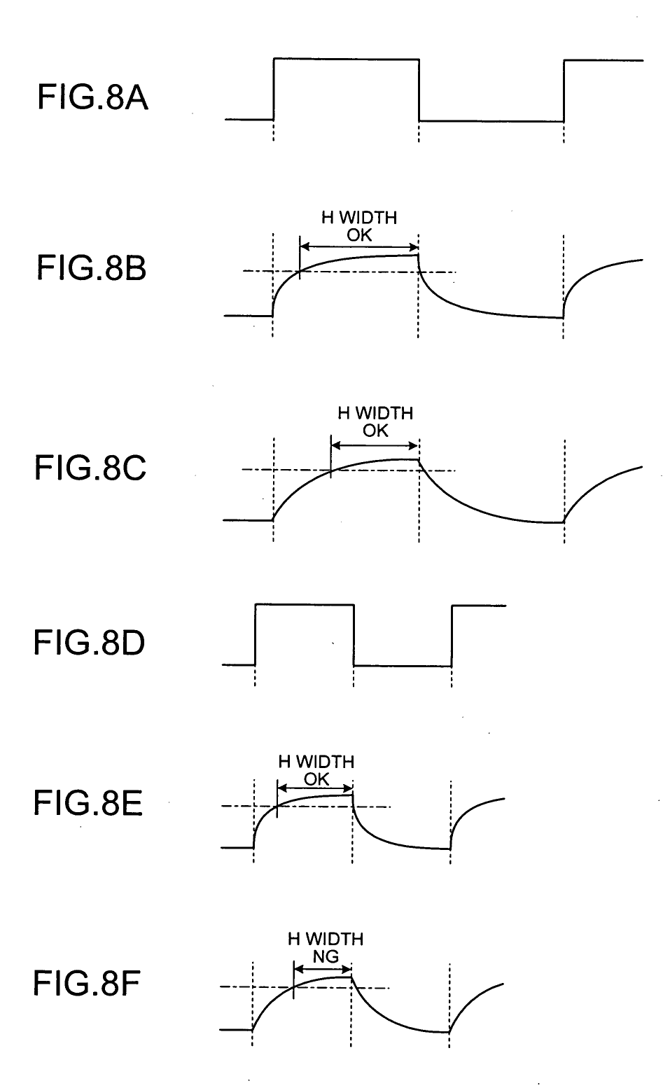

FIG. 5 is a functional block diagram of a CCD driving circuit in the document reading device according to the fourth embodiment. The configuration of the document reading device is the same as that according to the first embodiment except that a driver IC 13 used instead of the driver IC 5. The driver IC 13 is a driver unit that generates the driving signal from the timing signal and it functions as a time constant setting unit that switches the time constant. The driver IC 13 includes a control terminal of the output terminal.

The time constant required for each frequency are obtained by selecting an appropriate number of output terminals of the driver IC 13. Each output terminal of the driver IC 13 has a unique output resistance. The driver IC 13 that is divided into an A-line and a B-line has an output enable (OE) terminal for each line. The OE terminal of the A-line (OEA) is always enabled. The OE terminal of the B-line (OEB) is switched between enabled and disabled. By appropriately switching the OE terminal, whether to make the output resistance parallel can be selected and the time constant can be set. Therefore, an object of the invention can be achieved without particularly requiring any components other than the conventional circuit configuration. The control procedure is the same as that in the flowchart in FIG. 2.

As described above, the document reading device according to the fourth embodiment selects ON/OFF of the spread spectrum, and selects the size of the time constant of the timing signal depending on the operation mode. Therefore, it is possible to suppress occurrence of radiation noise and maintain image quality even in high-image-quality mode or high-speed mode.

Further effects and variation examples can be easily achieved by persons having ordinary skills in the art. The embodiments of the present invention are not limited to specific embodiments such as those explained above. Various modifications can be made without departing from the spirit and scope of the accompanying claims and equivalent invention.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A document reading device comprising:
a light source that irradiates a document;
an optical system that receives light reflected from the document and creates an optical image of the document from received light;
a photoelectric converting unit that converts the optical image into an electric signal based on a noise-reduced timing signal;
a clock generating unit that generates an original clock signal;
a spread spectrum unit that spreads the frequency of the original clock signal based on a spread spectrum width thereby generating a real clock signal;
a timing-signal generating unit that generates a timing signal based on the real clock signal;
a driving unit that supplies the timing signal to the photoelectric converting unit;
a harmonic-noise reducing unit that reduces harmonic noise of the timing signal in a plurality of harmonic noise reduction stages and supplies noise-reduced timing signal to the photoelectric converting unit;
a spread-spectrum control unit that sets the spread spectrum width in the spread spectrum unit; and
a noise-reduction setting control unit that determines a combination of the spread spectrum width to be set by the spread-spectrum control unit and number of the harmonic noise reduction stages to be used by the harmonic-noise reducing unit depending on an operation mode.

2. The document reading device according to claim 1, wherein
the spread-spectrum control unit outputs a no-spread signal, which contains a no-spread spectrum width that indicates not to spread the frequency, to the spread spectrum unit, and
the spread spectrum unit, upon receiving the no-spread signal, regularly or randomly changes the frequency of the original clock signal based on the no-spread spectrum width, and generates the actual clock signal.

3. The document reading device according to claim 1, wherein the noise-reduction setting control unit increases the spread spectrum width and reduces the number of the harmonic noise reduction stages when the operation mode is high-speed medium-image-quality mode.

4. The document reading device according to claim 3, wherein the high-speed medium-image-quality mode is monochrome mode.

5. The document reading device according to claim 1, wherein the noise-reduction setting control unit decreases the spread spectrum width and increases the number of the harmonic noise reduction stages when the operation mode is medium-speed high-image-quality mode.

6. The document reading device according to claim 5, wherein the medium-speed high-image-quality mode is color mode.

7. The document reading device according to claim 1, wherein
the clock generating unit generates a plurality of original clock signals having differing frequencies, and
the noise-reduction setting control unit determines the combination of the spread spectrum width and the number of the harmonic noise reduction stages depending on the frequencies of the original clock signals.

8. The document reading device according to claim 1, wherein the harmonic-noise reducing unit is a RC-integration circuit that includes a capacitor and a resistor having a time constant setting unit.

9. The document reading device according to claim 8, wherein the time constant setting unit sets the time constant by a semiconductor element having a variable ON resistance value.

10. The document reading device according to claim 8, wherein the time constant setting unit sets the time constant by a number of output terminals in the driving unit.

11. A document reading method comprising:
spreading a frequency of an original clock signal based on a spread spectrum width thereby generating a real clock signal;
generating a timing signal based on the real clock signal;
reducing noise in the timing signal in a plurality of harmonic noise reduction stages to thereby obtain a noise-reduced timing signal;
converting an optical image obtained by scanning a document into an electric signal based on the noise-reduced timing signal; and
setting the spread spectrum width at the spreading and number of the harmonic noise reduction stages at the reducing depending on an operation mode.

12. The document reading method according to claim 11, further comprising outputting a no-spread signal, which contains a no-spread spectrum width that indicates not to spread the frequency, and
the spreading includes receiving the no-spread signal, regularly or randomly changing the frequency of the original clock signal based on the no-spread spectrum width when generating the actual clock signal.

13. The document reading method according to claim 11, wherein, when the operation mode is high-speed medium-image-quality mode, the setting includes increasing the spread spectrum width and reducing the number of the harmonic noise reduction stages.

14. The document reading method according to claim 13, wherein the high-speed medium-image-quality mode is monochrome mode.

15. The document reading method according to claim 11, wherein, when the operation mode is medium-speed high-image-quality mode, the setting includes decreasing the spread spectrum width and increasing the number of the harmonic noise reduction stages.

16. The document reading method according to claim 15, wherein the medium-speed high-image-quality mode is color mode.

17. The document reading method according to claim 11, further comprising generating a plurality of original clock signals having differing frequencies, and
the setting includes setting the spread spectrum width and the number of the harmonic noise reduction stages depending on the frequencies of the original clock signals.

18. The document reading method according to claim 11, wherein the harmonic noise of the timing signal is reduced by a RC-integration circuit including a resistor and a capacitor, of which the time constant can be changed.

19. The document reading method according to claim 18, wherein the time constant is set by a semiconductor element having a variable ON resistance value.

20. The document reading method according to claim 18, wherein the time constant is set by a number of output terminals of a driving unit in which the resistor is included.
